(19) United States
(12) Patent Application Publication
(10) Pub. No.: US 2003/0158748 A1
(43) Pub. Date: Aug. 21, 2003

(54) Merchanding system

(76) Inventor: Ryan Lepianka, Oak Creek, WI (US)

Correspondence Address: Kenneth G. Lemke, Foley & Lardner, Suite 3800, 777 East Wisconsin Avenue, Milwaukee, WI, 53202-5306, US

(21) Appl. No.: 10/345,100

(22) Filed: Jan. 15, 2003

Related U.S. Application Data
(60) Provisional application No. 60/349,298, filed on Jan. 15, 2002.

(51) Int. Cl. G06F 17/60

(52) U.S. Cl. 705/1

(57) ABSTRACT

A merchandising system for use within a commercial setting such as a retail store, to accommodate at least a first product set, and to merchandise the first product set to a customer includes a first display unit, a second display unit, a third display unit, a first indicia provided near the first display unit, a second indicia provided near the second display unit, and a third indicia provided near the third display unit. The first indicia, the second indicia, and the third indicia direct the customer to the first display unit, to the second display unit, and to the third display unit.

### CROSS-REFERENCE TO RELATED PATENT APPLICATIONS

The present application claims the benefit of priority as may be available under 35 U.S.C. §§119-21 from the following application: U.S. Patent Application No. 60/349,298 (“MERCHANDISING SYSTEM”) filed Jan., 15, 2002 (incorporated by reference herein).

### BACKGROUND

The present invention relates to a merchandising system. The present invention more specifically relates to a merchandising system having display units such as shelf systems and providing information to a user for interactivity.

Conventional merchandising systems are provided within a retail environment (such as a store) to present, display, store and merchandise various products to consumers. However, many products may require input or assistance from a person knowledgeable about those products to more effectively merchandise those products. Such a person may be a salesperson, clerk, representative, etc. The salesperson may provide assistance to a customer as to which products, set of products, or combination of products that a customer should select. For example, a swimming pool may require multiple products to effectively maintain. A customer, such as a homeowner, may not have the level of familiarity (or knowledge) as to which products, or combination of products, may be necessary to effectively maintain or take care of his/her pool. The customer may likely require assistance in selecting products. However, assistance that a customer may need may not always be available (e.g., not enough clerks to assist the volume of customers, a clerk may not be found/available, etc.). Furthermore, conventional merchandising systems may not be well suited to provide a customer with assistance (or information) regarding products to assist the customer in selection. Furthermore, conventional merchandising systems may not be well suited for retail sales of a product set (comprised of a collection of related articles and/or articles used in association with each other) within a typical retail outlet or store. For example, a consumer may have difficulty identifying an area within the retail outlet which would have the products or product set which they are searching for.

Accordingly, it would be advantageous to provide a merchandising system which may be used in to merchandise, display, store and/or present a set of products in settings such as consumer settings, stores, retail outlets, commercial settings, etc. to a consumer. It would further be advantageous to provide a merchandising system which may provide guidance, information, and/or customer support to a consumer purchasing one or more products from a set of products. It would further be advantageous to provide a merchandising system which would assist in more effectively merchandising products such as pool maintenance products. It would further be advantageous to provide a merchandising system which may provide a “store-within-a-store” (e.g., a separate display environment within an existing merchandising outlet, store, or retail outlet) to allow a consumer to more readily identify a location or area a product or product set would be provided. It would further be advantageous to provide a merchandising system that is intended to provide for the display of multiple products within one setting. It would further be advantageous to provide a merchandising system which may provide guidance to a customer, which also may relieve sales staff or other support staff from consumer inquiry.

It would be desirable to provide a merchandising system of a type disclosed in the present application that includes any one or more of these or other advantageous features.

### SUMMARY

The present invention relates to a merchandising system for use within a commercial setting such as a retail store, to accommodate at least a first product set, and to merchandise the first product set to a customer. The merchandising system includes a first display unit, a second display unit, a third display unit, a first indicia provided near the first display unit, a second indicia provided near the second display unit, and a third indicia provided near the third display unit. The first indicia, the second indicia, and the third indicia direct the customer to the first display unit, to the second display unit, and to the third display unit.

The present invention further relates to a merchandising system, provided within a retail outlet, for assisting a customer with selecting pool maintenance products. The merchandising system includes a first display unit, a second display unit and a third display unit, a first sign provided near the first display unit, a second sign provided near the second display unit and a third sign provided near the third display unit. The first sign designates the first display unit as a first station. The second sign designates the second display unit as a second station. The third sign designates the third display unit as a third station. The first sign, the second sign and the third sign are configured to direct or assist the customer to the first display unit, to the second display unit and to the third display.

The present invention further relates to a merchandising system provided within a retail store. The merchandising system includes a first means for displaying products to a customer, a second means for displaying products to a customer and a third means for displaying products to a customer. The merchandising system further includes a first means for providing information to the customer, a second means for providing information to the customer and a third means for providing information to the customer. The first means for providing information, the second means for providing information and the third means for providing information are configured to direct or assist the customer to the first means for displaying products, the second means for displaying products and the third means for displaying products.

### BRIEF DESCRIPTION OF THE DRAWINGS

FIG. 1 is a perspective view of a merchandising system according to an exemplary embodiment.

FIG. 2 is a perspective view of a first display unit for use with the merchandising system shown in FIG. 1.

FIG. 3 is a perspective view of a second display unit for use with the merchandising system shown in FIG. 1.

FIG. 4 is a perspective view of a third display unit for use with the merchandising system shown in FIG. 1.

FIG. 5 is a perspective view of a fourth display unit for use with the merchandising system shown in FIG. 1.

FIG. 6 is a perspective view of a first component of a customer service center for use with the merchandising system shown in FIG. 1.

FIG. 7 is a perspective view of a second component of a customer service center for use with the merchandising system shown in FIG. 1.

FIG. 8 is a perspective view of a third component of a customer service center for use with the merchandising system shown in FIG. 1.

FIG. 9 is a perspective view of a fourth component of a customer service center for use with the merchandising system shown in FIG. 1.

FIG. 10 is a schematic top plan view of a merchandising system provided within a retail outlet such as a retail store.

FIG. 11 is a schematic top plan view of a merchandising system according to an alternative embodiment.

### DETAILED DESCRIPTION OF THE PREFERRED EMBODIMENTS

According to various exemplary embodiments, a merchandising system may be provided within an existing retail or display environment (such as a retail store) to provide a customer with assistance or guidance in selection of products. According to a particularly preferred embodiment, the merchandising system may be provided as a store within a store for the merchandising of pool maintenance products. The merchandising system may create an area or space that a customer may recognize as a separate “store” dedicated toward the merchandising of particular types of products (e.g., pool maintenance products). The “store within a store” may be used in retail outlets selling a wide variety of products (such as a department store) to identify or separate a store within the department store which is focused or dedicated to merchandising products of a certain type or set. According to an alternative embodiment, the “store within a store” may be used in a retail outlet selling certain type of products (such as a pool maintenance store) to identify or separate an area within the pool maintenance store which is focused or dedicated to merchandising products of a certain brand, manufacturer, or product subset (such as pool maintenance chemicals).

The arrangement and configuration of the merchandising system advantageously provides the customer with information to assist in the selection of one or more products from a set of particular products. Information or other indicia may be provided on, near, above, or in front of a number of display units (such as shelving units, racks, grids, etc). The display units are configured to store and present products to customers. Additional information or indicia may be presented as a guide to inform the customer as to the layout, purpose and arrangement of products provided on the display units. The customer, using one or more of the indicia provided, may then be directed or guided to various display units (or stations) to select products provided on the display unit.

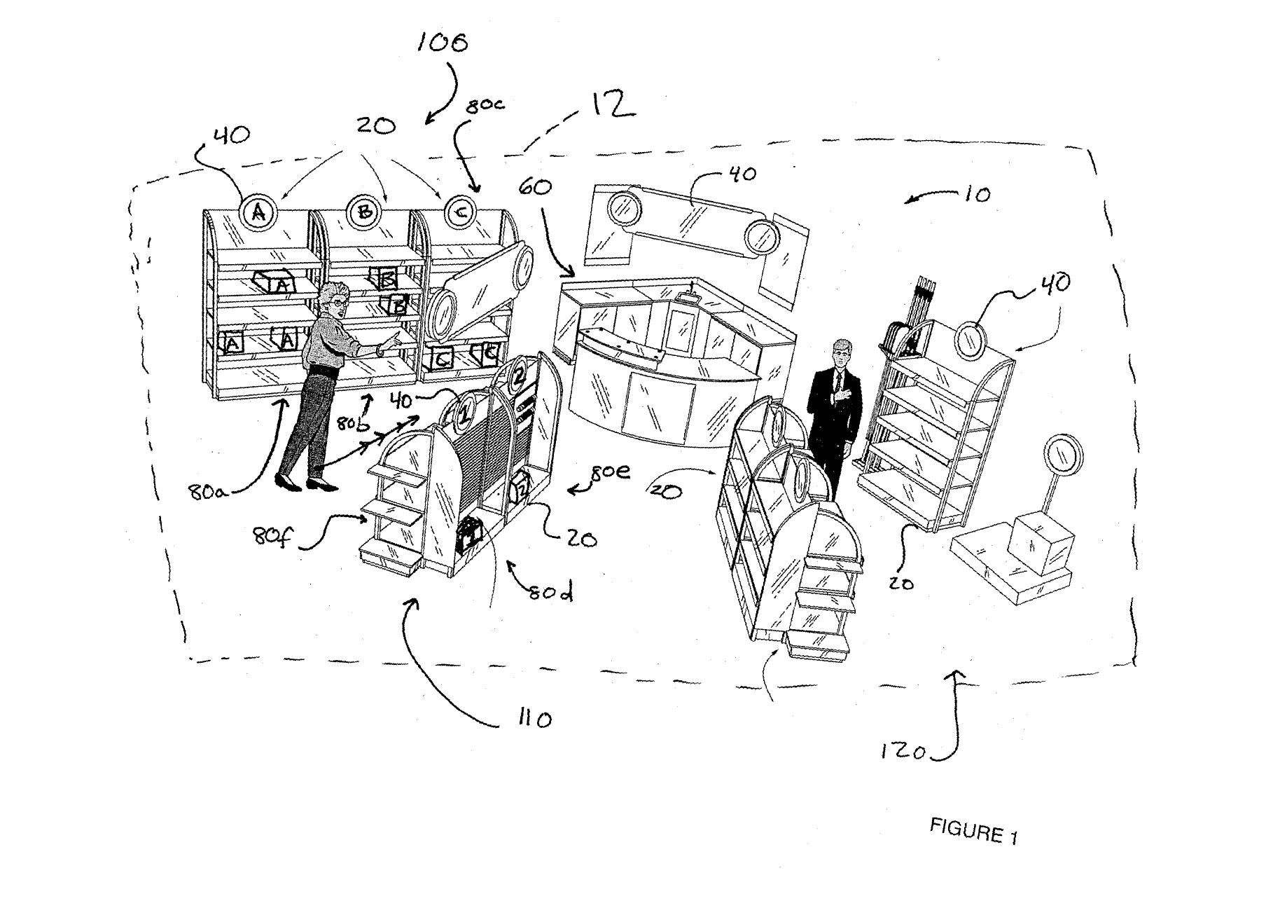

According to an exemplary embodiment shown in FIG. 1, a merchandising system 10 comprises one or more display units 20 (such as shelving units) and/or systems, in combination with information sets or indicia 40 (such as promotional and/or informational indicia, signage, etc.) provided on or near display units 20.

As shown in FIGS. 1-8, merchandising system 10 may include one or more display units 20 (e.g. product display units, shelving units, shelving systems, display systems, display areas, etc.). According to one exemplary embodiment, display units 20 may be provided or distributed in an area or environment 12 within a consumer outlet, store, shopping center, display environment, display area, etc. For example, as shown in FIG. 10, merchandising system 10 is shown provided within another retail outlet 400, such as a store, department store, conventional commercial outlet, etc. According to alternative embodiments, display units may be distributed in a variety of different environments such as commercial settings, warehouses, etc. In a particularly preferred embodiment, merchandising system 10 is provided in a pool maintenance store, pool service store or other retail outlet providing pool maintenance products to consumers.

According to a particularly preferred embodiment, display units 20 may be provided with a similar design (including an overall look, impression, or feel). For example, as shown in FIGS. 1-3, display units 20 (which may be provided in a variety of heights and widths) have two side supports 22 with a radius or curvature 24 at the top of support 22. When merchandising system 10 is assembled, each individual display unit 20 may be associated or identified with other similar display units in merchandising system 10. Providing display units 20 with a similar design is intended to create a zone or area for a consumer to identify as containing associated products. According to one exemplary embodiment, the association of similar display units, in part, creates a “store-within-a-store.” According to alternative embodiments, display units need not be provided with a consistent look or design.

As shown in FIG. 1, display units 20 provide modularity in construction or assembly of merchandising system 10. For example, depending on space constraints, display considerations, layout, and other design concerns, one or more display units 20 may be provided next to each other to construct larger display areas. As shown in FIG. 1, three display units 20 may be placed next to each other to create a larger display unit. According to alternative embodiments, any number, configuration, and/or sizes of display units may be associated to create a zone or display area.

As shown in FIG. 1, merchandising system 10 further includes information or indicia 40 (such as instructional information, promotional information, and/or informational indicia) to be associated with one or more display units 20. Information 40 (such as indicia) may comprise colors, color schemes, numbers, numerals, letters, lettering, graphics, text, directional graphics, signs, etc.

Information 40 may be presented in a variety of locations within merchandising system 10. According to various exemplary embodiments, information 40 may be provided on a variety of supports, frames, brackets, displays, etc. For example, as shown in FIG. 1, information 40 may be provided on sign-holders provided on a display unit 20, free-standing signs or displays, banners provided above the environment, indicia provided on the product, posters, etc.

Information 40 may used to provide a level of coordination between merchandising system 10 and the products or product sets which are being merchandised in merchandising system 10.

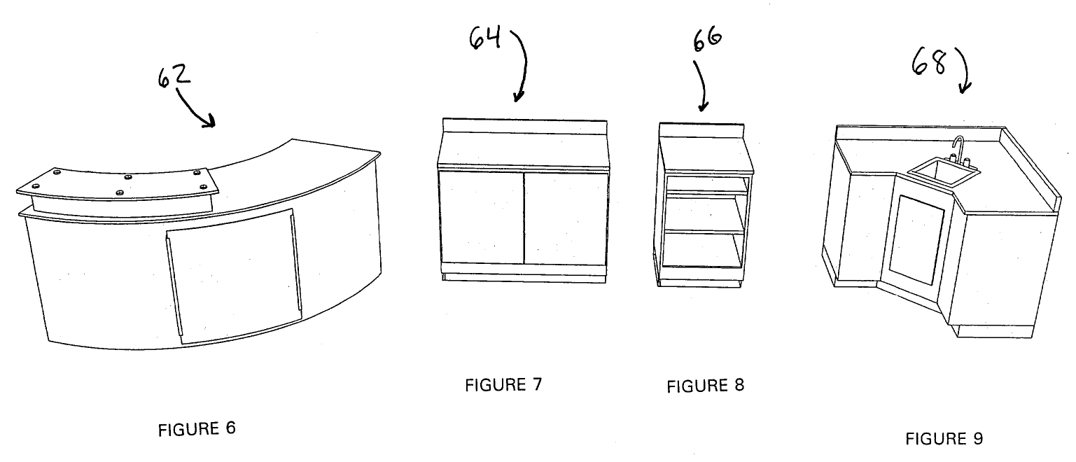

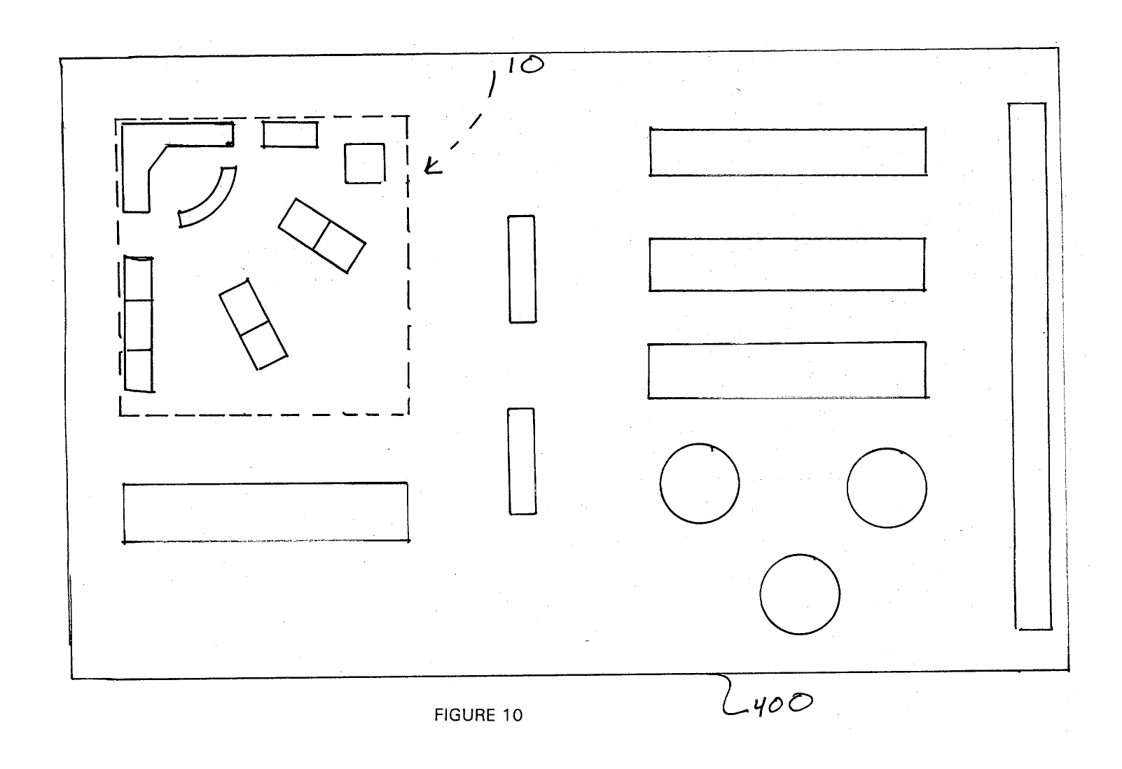

As shown in FIG. 1, merchandising system 10 may further comprise a service center 60. Service center 60 may be used to provide a work space for sales staff, clerks, etc. Service center 60 may comprise work surfaces, desks, cabinets, computer terminals, and/or a variety of other structures for use in a work space. According to one particularly preferred embodiment, shown in FIGS. 6-9, service center 60 may comprise a curved counter 62, two counters 64, two counters 66, and a corner counter module 68. According to an alternative embodiment, other arrangements, numbers and combinations of counters and modules may be used. Service center 60 may be provided to offer a user more information, or a center to provide customer assistance, services, etc. such as a water analysis center for pool maintenance.

As shown in FIG. 1, merchandising system 10 may have one or more stations (shown as stations 80). Each station 80 may be configured to display a certain product set, product type, and/or associated products. Each station 80 may comprise one or more display units 20, and one or more sets of information 40 associated with each station 80. Each station 80 may have information 40 provided with it to offer a user (such as a customer) information relating to products associated with that station. The stations may be arranged in such a fashion as to provide a user with information or guidance to go from station to station in order to obtain certain products or product sets.

According to a particularly preferred embodiment, merchandising system 10 is provided in a department store, pool maintenance store or pool service store. In pool maintenance, a wide variety of products and/or combinations of products may be needed to properly maintain a pool. Such products may include chemicals (such as chlorine, chlorine tablets, “Shock”, additives, chemical testing kits, testing chemicals, sanitizers, cleaning products, filters, etc.). However, an important requisite for pool maintenance is not only having the required products, but information of which products are required. The information provided with exemplary embodiments of the merchandising system, in addition to the lay-out of the display units, provides information and guidance to a customer purchasing products for pool maintenance. For example, as shown in FIG. 1, merchandising system is shown with three zones (e.g., zone 100, zone 110, and zone 120). Zones 100, 110, and 120 are provided as areas in which a consumer, wishing to service a pool, should visit in order to maintain a pool. Each zone may correspond to a certain type of maintenance for the pool (e.g. zone 100 may correspond to the products required for physically cleaning the pool (e.g. brushes, filters, scouring pads, skimmers, poles, etc.), zone 110 may correspond to the chemicals required for maintaining the water (e.g. chlorine, shock, testing chemicals, stabilizers, etc.), zone 120 may correspond to other pool maintenance products (e.g. sand, skimmers, etc.). According to another particularly preferred embodiment, zone 100 may be associated with products to maintain water quality, zone 110 may be associated with products to prevent algae growth, and zone 120 may be associated with products with chlorine maintenance of pool water.

According to an exemplary embodiment, merchandising system 10 may provide a variety of desired products or sizes of products at various stations of the various zones. For example, a customer may be guided or directed to zone 100 with indicia 40. In zone 100, merchandising system 10 may provide a consumer with three stations (stations 80a, 80b and 80c). Merchandising system 10 provides a consumer with certain products which they may choose from each station, as well as information used in deciding which products to select. As an example, a consumer may select a desired product or size of product at station 80a of zone 100. Merchandising system 100 will direct the consumer (via information 40) on to station 80b of zone 100. There, the consumer may then select a desired product or size of product at station 80b of zone 100. Merchandising system 10 will direct the consumer on to station 80c of zone 100. There, the consumer may select a desired product or size of product at station 80c of zone 100. Merchandising system 10 (and indicia 40) guides or directs the consumer from station to station within a zone, guides the consumer from zone to zone (if needed), and provides the consumer with the ability to select the required products needed for a certain task (e.g. a type of maintenance). The information provided with merchandising system 10 may then direct the consumer on toward zone 110, where the process of directing the consumer from station to station is repeated. For example, a sign may be used to inform the customer as to the different zones, the purposes or application of products within each zone, the differences between products in different zones, etc.

According to one exemplary embodiment, merchandising system 10 may provide one zone, with one or more stations within that zone. According to a particularly preferred embodiment, a customer may only visit one zone to acquire the necessary products for pool maintenance. According to an alternative embodiment, the merchandising system may provide one or more zones, and each zone may be provided with one or more stations within that zone.

According to another exemplary embodiment, merchandising system 10 may be provided with two or more unrelated zones. For example, zone 100 may be used in conjunction with pool care products that utilize chlorine. Station 80a may be used to provide different types of chlorine, station 80b may be used to provide different types of oxidizers, shock or burn-out, and station 80c may be used to provide different types of algaecides. Zone 110 may be used to provide a different line of products which do not utilize chlorine. According to a particularly preferred embodiment, stations 80d, 80e and 80f may be used to provide non-chlorine products that fulfill similar functions as the products which are provided in stations 80a-c.

According to exemplary embodiments of the present invention, one or more zones may be provided for use with the merchandising system. Also, one or more stations within each zone may be provided to display product that may be associated with the zone.

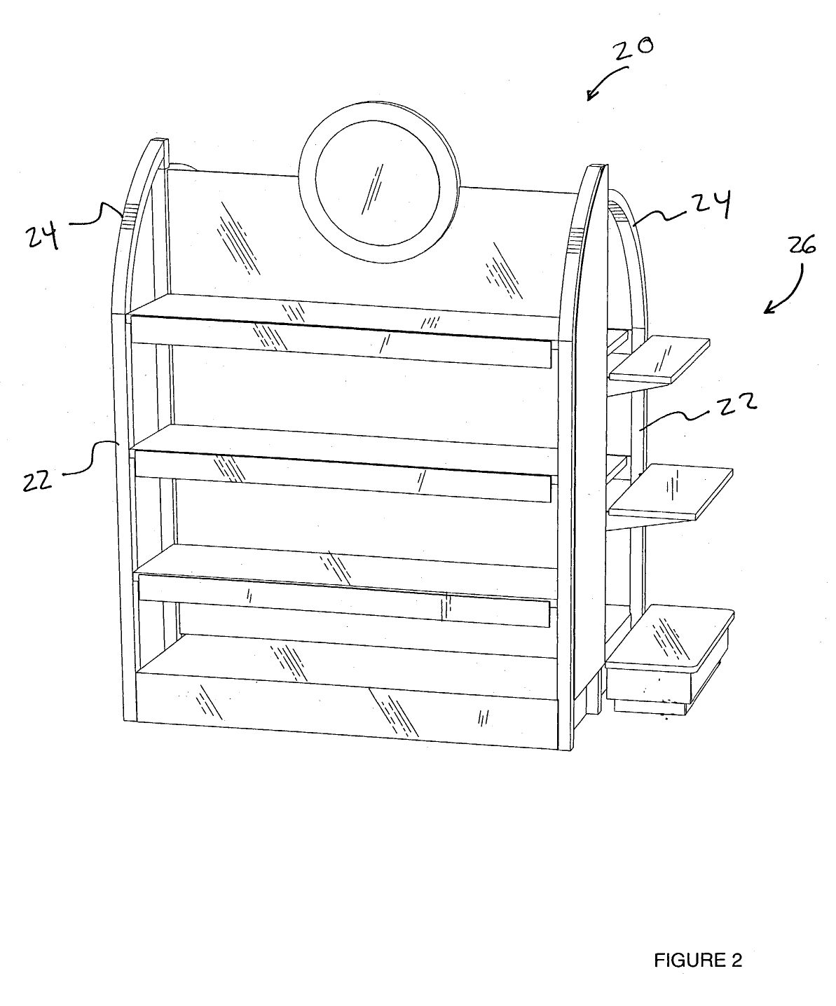

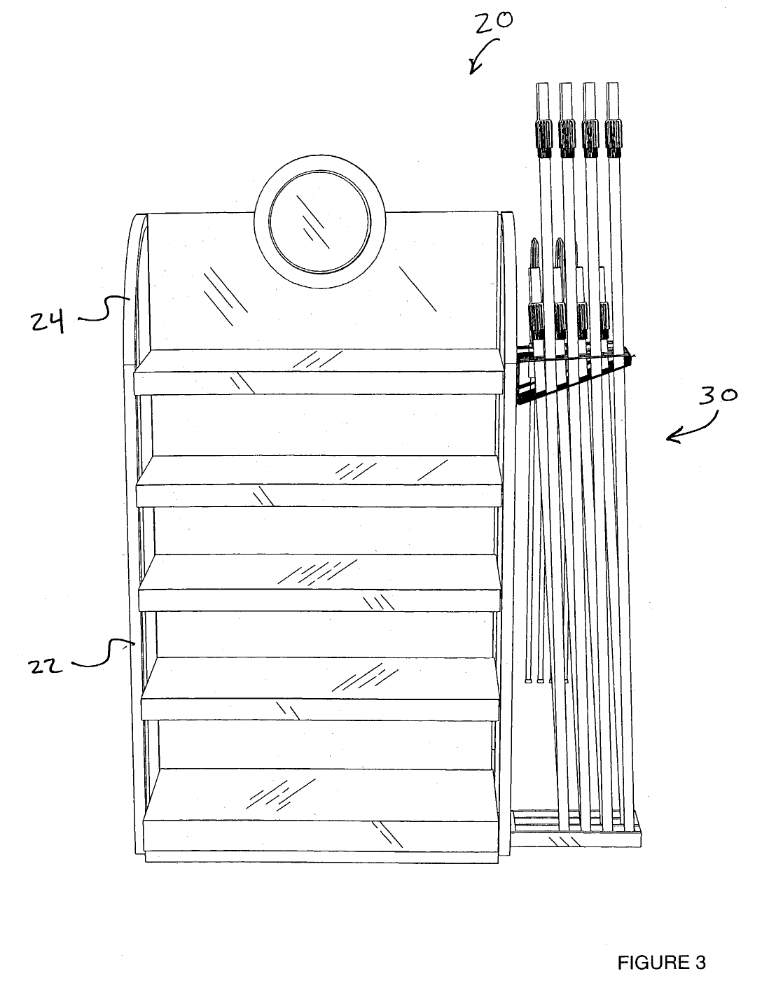

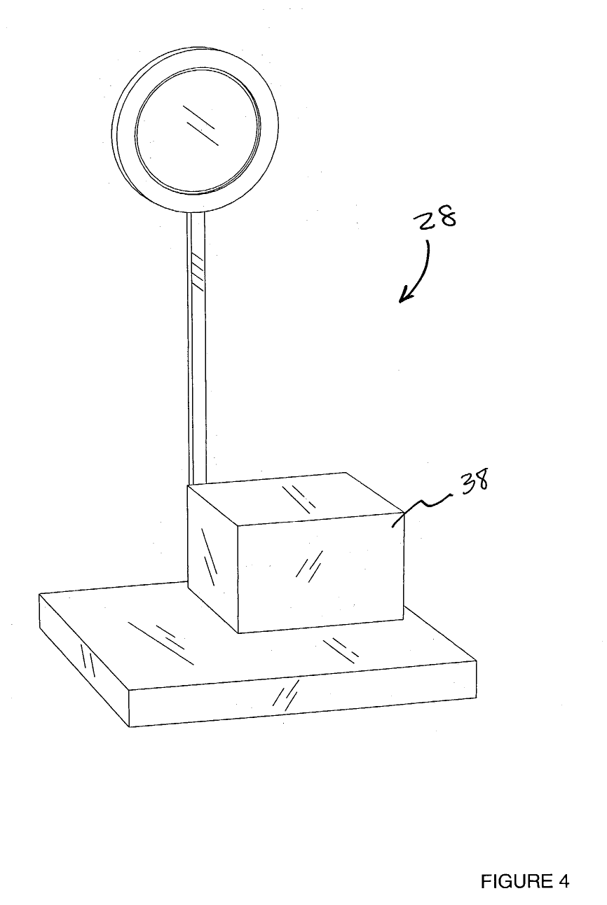

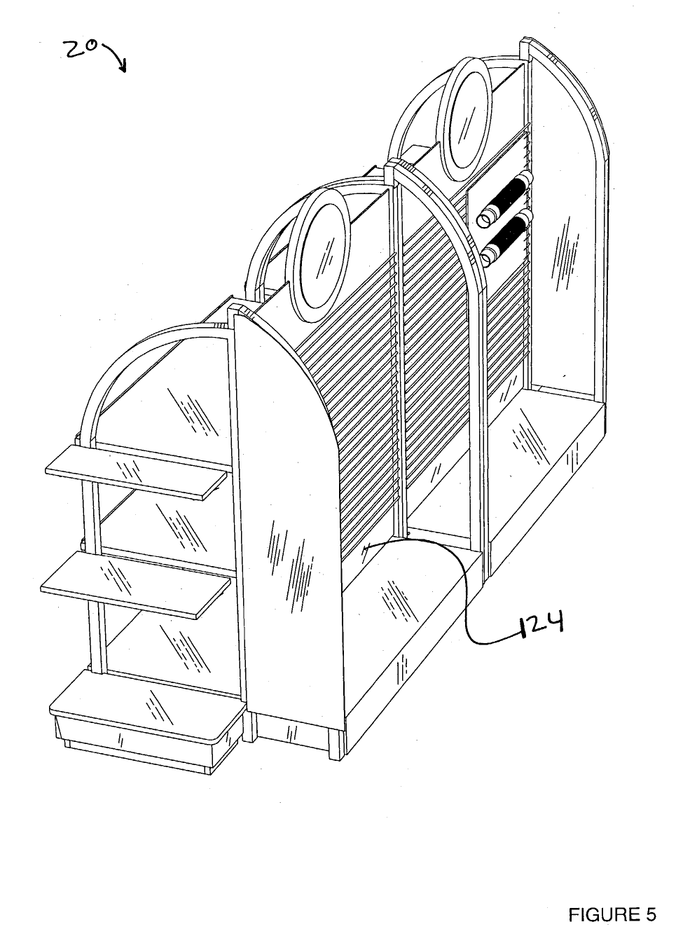

As shown in FIG. 1, merchandising system 10 may be provided with a variety of other display units. Merchandising system 10 may include a grid or wire backed display unit 124 (FIG. 5), a display unit configured to be provided on an end portion of another display unit (shown as end-caps 26 provided display units 20) (FIG. 2), floor displays 28 or “stack-outs” (FIG. 4), etc. According to a particularly preferred embodiment, a merchandising system “kit” includes four shorter display units: two display units 24 having a wire grid or wire backing (FIG. 5) and two units having shelves provided on both sides of the unit (FIG. 2). Additionally end caps 26 may be provided for use with the display units. Five taller display units (FIG. 3) are also provided in the particularly preferred embodiment. One of the taller display units also has a merchandiser 30 provided with it for merchandising and displaying longer objects such as poles, skimmers, etc. The merchandising system “kit” also has a display 28 provided for merchandising larger buckets of chlorine tablets on the floor of the display environment. Display 28 may include a structure 38 to allow multiple tiers or layers of product to be displayed. According to a particularly preferred embodiment, structure 38 may be re-positionable or otherwise moveable with respect to display 28.

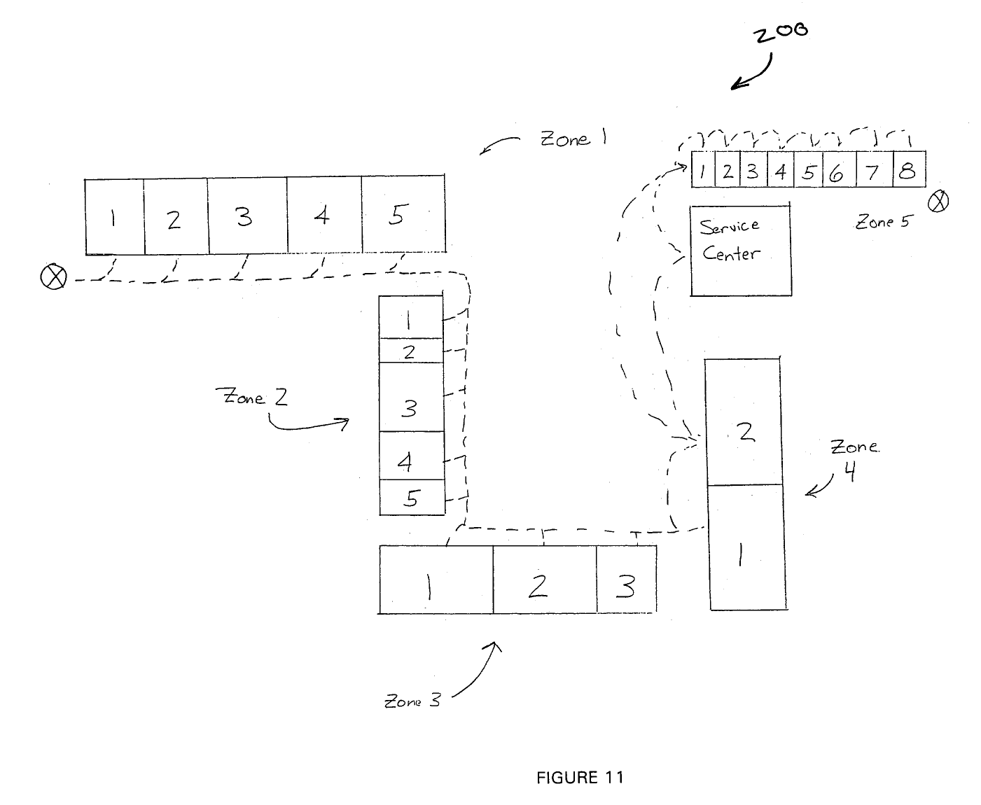

According to one exemplary embodiment, the physical positioning and orientation of the various zones facilitates the movement of a user from zone to zone. Illustrated in FIG. 11 is an exemplary merchandising system 200 showing a configuration and orientation of stations and zones which assist in moving or directing the customer from station to station, and then from zone to zone, depending on the maintenance requirements of the customer. Multiple paths of travel are illustrated by broken lines. A customer may be guided to travel along a specified path of travel in order to select products located along that path of travel.

According to various alternative embodiments, merchandising system 10 may be used in conjunction with a wide variety of products. The sale of such products may require customer support (such as sales clerks, etc.). By using exemplary embodiments of the merchandising system shown, consumers may be more guided or informed as to products which are recommended that they select. Merchandising system 10 advantageously may reduce the need for additional customer service (such as clerks, sales staff, attendants, etc.). Merchandising system 10 may be used to merchandise products which are used in part with a program or subscription type product set. For example, a specified program or subscription of certain pool chemicals may be useful in providing a customer with the necessary products needed throughout a season or other time period. The customer may frequent merchandising system 10 multiple times throughout the course of their subscription, and be informed or guided by merchandising system 10 as to which products they should select for that visit, time period, term, etc.

As shown in the FIGURES, the merchandising systems advantageously provide a level of interactivity between the merchandising system and a user such as a customer. The merchandising system provides information to the customer, facilitating the customer in selecting and/or using products that are merchandised by the merchandising system.

According to a particularly preferred embodiment, information 40 may correlate, mirror or mimic indicia on the product being merchandised. For example, information 40 may be signs numbered “1”, “2”, “3”, etc., lettered “A”, “B”, “C”, etc. and/or have colors associated with certain indicia (e.g. Section “A” may be colored green, Section “B” may be colored blue, Section “C” may be colored red, etc. A first indicia (such as the color and/or numbering scheme of the information) may correlate to second indicia on the product. For example, a blue colored “B” on the product may corresponds to a blue section “B” signage provided near the station and product, a red colored “C” on the product corresponds to the red section “C” signage, etc.). This may also aid in product merchandising, product selection by the consumer, product choice, etc.

It is also important to note that the construction and arrangement of the elements of the merchandising system as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter of the present inventions. For example, elements shown as integrally formed may be constructed of multiple parts or elements show as multiple parts may be integrally formed, the operation of the assemblies may be reversed or otherwise varied, the length or width of display units or other elements of the system may be varied, the nature or number of stations, zones, display units, etc. may be varied. It should be noted that the elements and/or assemblies of the system may be constructed from any of a wide variety of materials that provide sufficient strength or durability, including any of a wide variety of materials, such as metals, moldable or extrudable plastic materials in any of a wide variety of colors, textures and combinations. It should also be noted that the merchandising system may be used in association a wide variety of products in any of a wide variety of other applications. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

What is claimed is:

1. A merchandising system for use within a commercial setting such as a retail store, to accommodate at least a first product set, and to merchandise the first product set to a customer, the merchandising system comprising:
a first display unit;
a second display unit;
a third display unit;
a first indicia provided near the first display unit;
a second indicia provided near the second display unit; and
a third indicia provided near the third display unit;
wherein the first indicia, the second indicia, and the third indicia direct the customer to the first display unit, to the second display unit, and to the third display unit.

2. The merchandising system of claim 1 wherein the first display unit, the second display unit and the third display unit form a first zone.

3. The merchandising system of claim 2 further comprising:
a fourth display unit;
a fifth display unit;
a sixth display unit;
a fourth indicia provided near the fourth display unit;
a fifth indicia provided near the fifth display unit; and
a sixth indicia provided near the sixth display unit;
wherein the fourth indicia, the fifth indicia, and the sixth indicia direct the customer to the fourth display unit, to the fifth display unit, and to the sixth display unit;
wherein the fourth display unit, the fifth display unit and the sixth display unit form a second zone.

4. The merchandising system of claim 3 further comprising a seventh indicia configured to direct the customer to select products from either of the first zone or the second zone.

5. The merchandising system of claim 3 further comprising a seventh indicia configured to direct the customer to select products from the first zone and then direct the customer to the second zone to select products from the second zone.

6. The merchandising system of claim 1 wherein the merchandising system forms a store within the commercial setting.

7. The merchandising system of claim 1 wherein the first display unit, to the second display unit, and to the third display unit are configured to receive a product set for maintenance of a pool.

8. The merchandising system of claim 1 wherein the first display unit, the second display unit, and the third display unit are configured to receive chemical products.

9. The merchandising system of claim 1 wherein the first display unit, the second display unit, and the third display unit are configured to receive pool maintenance chemical products.

10. The merchandising system of claim 1 wherein the merchandising system comprises a pool maintenance center.

11. The merchandising system of claim 1 further comprising a customer service center.

12. The merchandising system of claim 11 wherein the customer service center further comprises a water analysis center.

13. The merchandising system of claim 1 wherein the first display unit, the second display unit and the third display unit further comprise a kit having at least two relatively shorter display units, at least four relatively taller display units, a customer service center and a floor stack-out display unit.

14. The merchandising system of claim 1 wherein the first indicia, the second indicia and the third indicia correspond to indicia provided on the products displayed on the first display unit, the second display unit and the third display unit.

15. The merchandising system of claim 14 wherein the first indicia, the second indicia and the third indicia corresponding to indicia provided on the products displayed on the first display unit, the second display unit and the third display unit comprise at least one of numbering, lettering and coloring.

16. The merchandising system of claim 1 wherein the first indicia, the second indicia, and the third indicia directing the customer further comprises providing information to the customer to assist the customer in selecting at least one product provided on each of the first display unit, the second display unit and the third display unit.

17. A merchandising system, provided within a retail outlet, for assisting a customer with selecting pool maintenance products, the merchandising system comprising:
a first display unit, a second display unit and a third display unit;
a first sign provided near the first display unit, a second sign provided near the second display unit and a third sign provided near the third display unit;
wherein the first sign designates the first display unit as a first station;
wherein the second sign designates the second display unit as a second station;
wherein the third sign designates the third display unit as a third station;
wherein the first sign, the second sign and the third sign are configured to direct or assist the customer to the first display unit, to the second display unit and to the third display.

18. The merchandising system of claim 17 wherein the first station, the second station and the third station comprise a first zone.

19. The merchandising system of claim 17 further comprising:
a fourth display unit, a fifth display unit and a sixth display unit;
a fourth sign provided near the fourth display unit, a fifth sign provided near the fifth display unit and a sixth sign provided near the sixth display unit;
wherein the fourth sign designates the fourth display unit as a fourth station;
wherein the fifth sign designates the fifth display unit as a fifth station;
wherein the sixth sign designates the sixth display unit as a sixth station;
wherein the fourth sign, the fifth sign and the sixth sign are configured to direct or assist the customer to the fourth display unit, to the fifth display unit and to the sixth display.

20. The merchandising system of claim 19 wherein the fourth station, the fifth station and the sixth station comprise a second zone.

21. The merchandising system of claim 20 wherein the customer is directed to select products from either the first zone or the second zone.

22. The merchandising system of claim 20 wherein the customer is directed to select products from the first zone and then is further directed to the second zone to select products from the second zone.

23. The merchandising system of claim 17 wherein the merchandising system forms a store within the retail outlet.

24. The merchandising system of claim 17 wherein the first display unit, the second display unit and the third display are configured to receive chemical products.

25. The merchandising system of claim 17 wherein the merchandising system comprises a pool maintenance center.

26. The merchandising system of claim 17 further comprising a customer service center.

27. The merchandising system of claim 26 wherein the customer service center further comprises a water analysis center.

28. A merchandising system provided within a retail store, the merchandising system comprising:
a first means for displaying products to a customer, a second means for displaying products to a customer and a third means for displaying products to a customer;
a first means for providing information to the customer, a second means for providing information to the customer and a third means for providing information to the customer;
wherein the first means for providing information, the second means for providing information and the third means for providing information are configured to direct or assist the customer to the first means for displaying products, the second means for displaying products and the third means for displaying products.

29. The merchandising system of claim 28 wherein the first means for displaying products, the second means for displaying products and the third means for displaying products form a first display zone.

30. The merchandising system of claim 28 wherein the merchandising system forms a store within the retail store.

31. The merchandising system of claim 28 wherein the merchandising system comprises a pool maintenance center.

32. The merchandising system of claim 28 further comprising a customer service center.
